(19) United States
(12) Patent Application Publication
(10) Pub. No.: US 2024/0332761 A1
(43) Pub. Date: Oct. 3, 2024

(54) SOLID-STATE SECONDARY BATTERY

(71) Applicant: HONDA MOTOR CO., LTD., Tokyo (JP)

(72) Inventors: Takashi NAKAGAWA, Saitama (JP); Yohei NOJI, Saitama (JP); Kyohei IZUMI, Saitama (JP); Hiroki ICHIHARA, Saitama (JP)

(21) Appl. No.: 18/587,968

(22) Filed: Feb. 27, 2024

(30) Foreign Application Priority Data
Mar. 31, 2023 (JP) 2023-059659

(51) Int. Cl. H01M 50/586; H01M 4/02; H01M 4/38; H01M 50/59

(52) U.S. Cl. CPC H01M 50/586; H01M 4/382; H01M 50/59; H01M 2004/027

(57) ABSTRACT

The solid-state secondary battery of this invention including an electrode laminate and an outer case to house the electrode laminate, wherein the electrode laminate has a positive electrode layer, a negative electrode layer and a solid electrolyte layer placed between the positive electrode layer and the negative electrode layer, the positive electrode layer has a positive current collector and a positive active material layer, and the circumferences of the positive active material layer and the solid electrolyte layer are surrounded by an insulating frame having a volume resistivity at 20° C. of 1×10¹² Ω·cm or more and a porosity of 40% or less.

This application is based on and claims the benefit of priority from Japanese Patent Application No. 2023-059659, filed on 31 Mar. 2023, the content of which is incorporated herein by reference.

### BACKGROUND OF THE INVENTION

### Field of the Invention

The present invention relates to a solid-state secondary battery.

### Related Art

In order to ensure that more people can access reasonable, reliable, sustainable and advanced energy, a secondary battery contributing to good energy efficiency has been researched and developed in recent years. Among secondary batteries, a solid-state secondary battery using a solid electrolyte is good and particularly has attracted attention because the solid electrolyte is nonflammable and thus safety is improved, and the energy density is higher.

In solid-state secondary batteries, a metal ion such as lithium ion used as a charge transfer medium may be precipitated between a solid electrolyte layer and a negative electrode layer by repeating charging and discharging. There is a risk that the performance of the solid-state secondary batteries may be reduced because, for example, interface joining properties are reduced due to the above metal precipitation. In order to overcome this problem, a technique is known, in which a layer which covers a negative current collector and on which lithium metal can be precipitated is provided so that lithium metal approximately uniformly precipitates on the surface of the covering layer, thereby making it difficult for dead lithium to generate (see e.g. Patent Document 1).
Patent Document 1: Japanese Unexamined Patent Application, Publication No. 2018-129159

### SUMMARY OF THE INVENTION

Incidentally, the issues of the solid-state secondary batteries are to obtain a higher capacity and improve cycle characteristics. The use of lithium metal as a negative active material has been investigated for a solid-state secondary battery with a higher capacity. In the solid-state secondary batteries using lithium metal as a negative active material, however, the thickness of a negative electrode layer varies largely due to charging and discharging. In addition, in the solid-state secondary batteries, a metal ion, a charge transfer medium, may be easily deposited on the end portion of a solid electrolyte layer when the dimensions, structure design and process conditions are unsuitable. In particular, when an interlayer is provided between a solid electrolyte layer and a negative current collector, a metal ion may be easily deposited on the end portion of the interlayer. When a metal ion is deposited on the end portions of the solid electrolyte layer and the interlayer, the positive electrode layer and the negative electrode layer may short-circuit because the deposited metal is accumulated, and resistance may increase because side reactions are locally caused. Therefore, there is a risk that cycle characteristics may be reduced.

The present invention has been made in view of the above, and an object thereof is to provide a solid-state secondary battery in which the thickness of a negative electrode layer varies largely due to charging and discharging, also a metal ion is difficult to deposit on the end portions of a solid electrolyte layer and an interlayer even when charging and discharging are repeated, and cycle characteristics are good. Therefore, the solid-state secondary battery contributes to energy efficiency.

The present inventors found that the above problems could be solved by surrounding the circumferences of a positive active material layer in a positive electrode layer and a solid electrolyte layer by an insulating frame with predetermined volume resistivity and porosity, thereby completing the present invention. Therefore, the present invention provides the following.

(1) A solid-state secondary battery, including an electrode laminate and an outer case to hold the electrode laminate, in which the electrode laminate has a positive electrode layer, a negative electrode layer and a solid electrolyte layer placed between the positive electrode layer and the negative electrode layer, the positive electrode layer has a positive current collector and a positive active material layer, and the circumferences of the positive active material layer and the solid electrolyte layer are surrounded by an insulating frame having a volume resistivity at 20° C. of 1×10¹² Ω· cm or more and a porosity of 40% or less.

According to the solid-state secondary battery in (1), a metal ion released from the positive electrode layer and the negative electrode layer is less likely to deposit on the end portion of the solid electrolyte layer during charging and discharging because the circumferences of the positive active material layer and the solid electrolyte layer are surrounded by the insulating frame having the above volume resistivity and porosity. Because of this, the positive electrode layer and the negative electrode layer are less likely to cause a short circuit. Therefore, the solid-state secondary battery in (1) has good cycle characteristics.

(2) The solid-state secondary battery according to (1), in which the porosity of the insulating frame is 20% or less.

According to the solid-state secondary battery in (2), a metal ion released from the positive electrode layer and the negative electrode layer is further less likely to deposit on the end portion of the solid electrolyte layer during charging and discharging because the porosity of the insulating frame is small, 20% or less, and thus the void diameter in the insulating frame is small and the structure of the insulating frame is easily retained. Because of this, the positive electrode layer and the negative electrode layer can be further less likely to cause a short circuit.

(3) The solid-state secondary battery according to (1) or (2), having an interlayer placed between the negative electrode layer and the solid electrolyte layer, in which the porosity of the interlayer is greater than the porosity of the solid electrolyte layer.

According to the solid-state secondary battery in (3), even when the interlayer is included, because the circumferences of the positive active material layer and the solid electrolyte layer are surrounded by the above insulating frame, the positive electrode layer and the negative electrode layer are less likely to cause a short circuit. In addition, because the porosity of the interlayer is greater than the porosity of the solid electrolyte layer, uneven metal deposition on the negative electrode layer interface can be suppressed, and cycle characteristics can be further improved.

(4) The solid-state secondary battery according to (3), in which the insulating frame is extended to the circumference of the interlayer.

According to the solid-state secondary battery in (4), because the insulating frame is extended to the circumference of the interlayer, a metal ion is less likely to deposit on the end portion of the interlayer. Because of this, the positive electrode layer and the negative electrode layer are further less likely to cause a short circuit.

(5) The solid-state secondary battery according to (3) or (4), in which the thickness of the interlayer in the laminate direction of the electrode laminate is 5 μm or less.

According to the solid-state secondary battery in (5), because the thickness of the interlayer is 5 μm or less, the deposition site of metal serving as a charge transfer medium during charging can be located between the interlayer and the negative electrode layer. Thereby, a frequency of direct contact between the electrolyte layer and the precipitated metal can be considerably decreased and local degradation and current concentration in the electrolyte layer can be suppressed, improving cyclability and preservability. Moreover, a relatively elastic interlayer can be placed between the hard electrolyte layer and hard deposited metal, and thus it becomes easy to follow expansion and contraction due to the deposition and dissolution of the metal, so that a uniform reaction in an in-plane direction and a thickness direction can be performed, resulting in effects of reducing the resistance and improving the cyclability.

(6) The solid-state secondary battery according to any one of (3) to (5), in which the interlayer includes metal nanoparticles and amorphous carbon.

According to the solid-state secondary battery in (6), the electron conductivity of the interlayer can be secured, and also particles forming the interlayer and the charge transfer medium can be prevented from reacting to form an alloy.

(7) The solid-state secondary battery according to any one of (1) to (6), in which a negative active material is lithium metal.

According to the solid-state secondary battery in (7), a high capacity can be obtained because the negative active material is lithium metal.

According to the present invention, it is possible to provide a solid-state secondary battery, in which the thickness of a negative electrode layer varies largely due to charging and discharging, also a metal ion is difficult to deposit on the end portions of a solid electrolyte layer and an interlayer even when charging and discharging are repeated, and cycle characteristics are good.

### BRIEF DESCRIPTION OF THE DRAWINGS

FIG. 1 is a top view of an electrode laminate in a solid-state secondary battery according to one embodiment of the present invention;

FIG. 2 is a cross-sectional view taken along the line II-II in FIG. 1;

FIG. 3 is a cross-sectional view showing a state in which the electrode laminate in FIG. 2 is charged; and

FIG. 4 is a cross-sectional view of a solid-state secondary battery according to one embodiment of the present invention.

### DETAILED DESCRIPTION OF THE INVENTION

Embodiments of the present invention will now be illustrated with reference to the drawings. It should be noted, however, that the embodiments below describe examples of the present invention, and the present invention is not limited thereto.

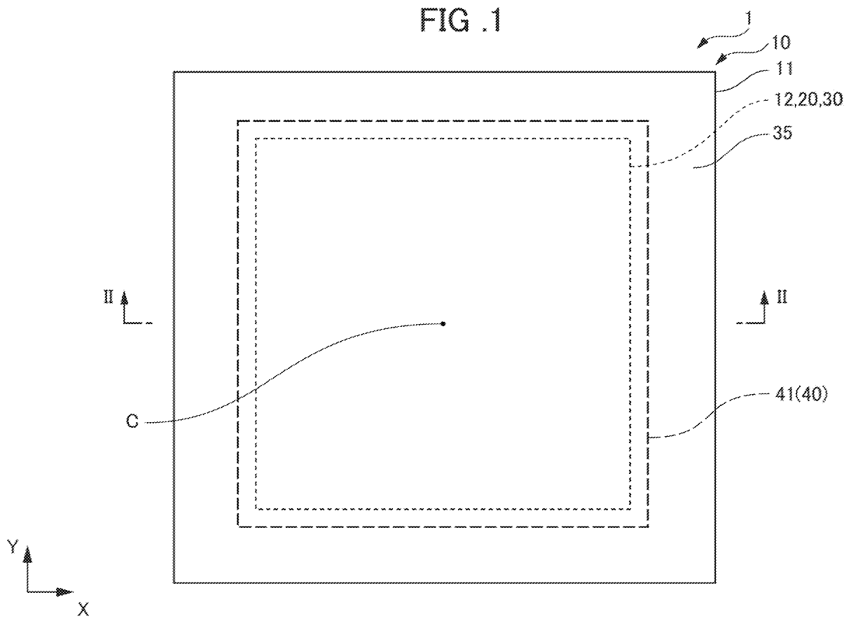

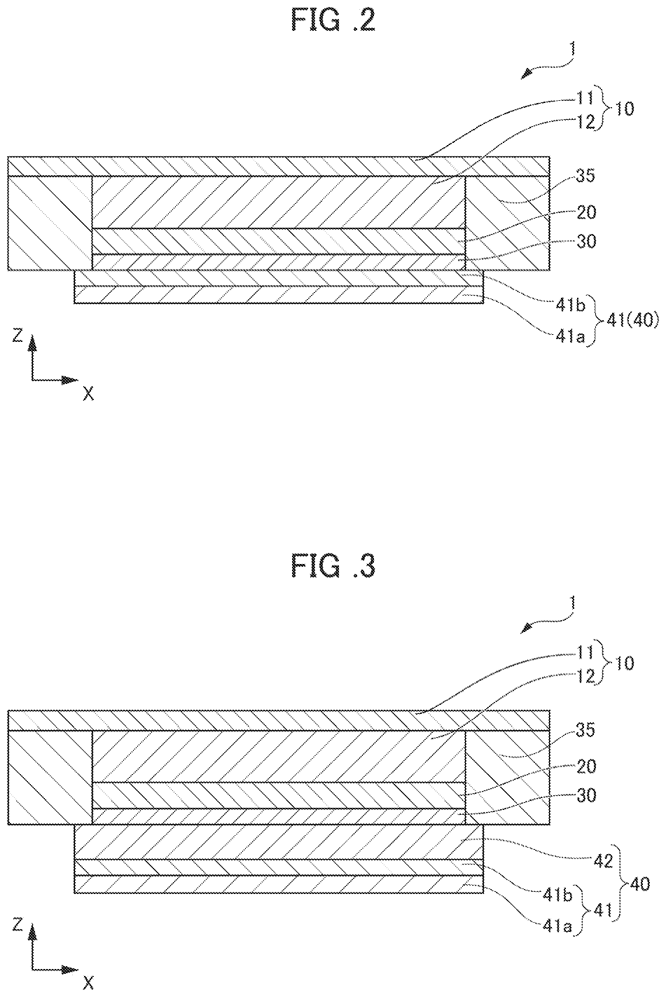

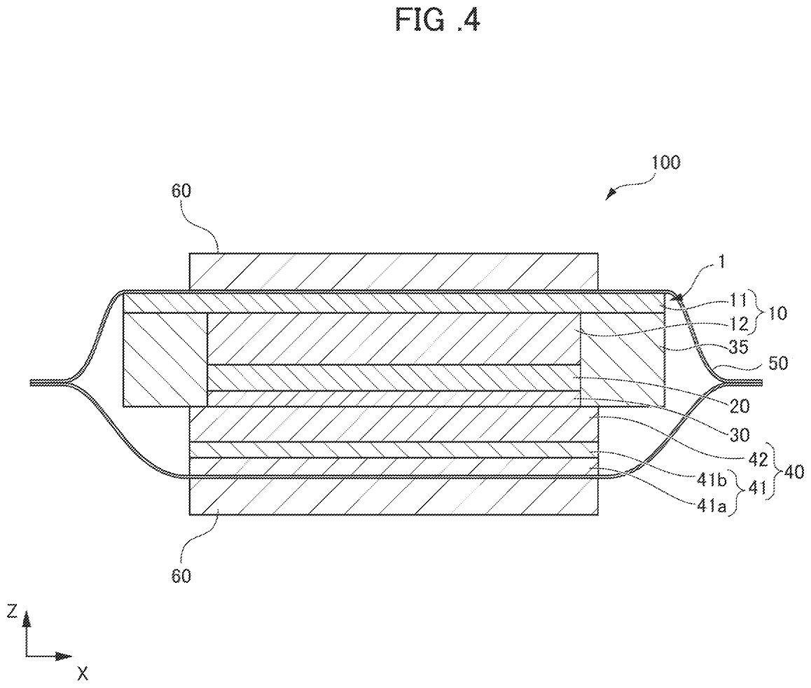

FIG. 1 is a top view of an electrode laminate in a solid-state secondary battery according to one embodiment of the present invention. FIG. 2 is a cross-sectional view taken along the line II-II in FIG. 1, and FIG. 3 is a cross-sectional view showing a state in which the electrode laminate in FIG. 2 is charged. FIG. 4 is a cross-sectional view of a solid-state secondary battery having the electrode laminate shown in FIGS. 1 to 3. In FIGS. 1 to 4, the X direction shown by the arrow X is one direction parallel to the top surface when the electrode laminate is viewed from the top. The Y direction shown by the arrow Y is a direction parallel to the top surface when the electrode laminate is viewed from the top, and perpendicular to the X direction. The Z direction shown by the arrow Z is the laminate direction of the electrode laminate.

The solid-state secondary battery 100 of the present embodiment includes an electrode laminate 1 as shown in FIG. 4. The electrode laminate 1 is a laminate in which a positive electrode layer 10, a solid electrolyte layer 20, an interlayer 30, and a negative electrode layer 40 are laminated in this order as shown in FIGS. 1 to 3. The positive electrode layer 10 includes a positive current collector 11 and a positive active material layer 12. The circumferences of the positive active material layer 12, the solid electrolyte layer 20 and the interlayer 30 are surrounded by an insulating frame 35. The negative electrode layer 40 includes a negative current collector 41. It should be noted that the electrode laminate 1 shown in FIGS. 1 and 2 are in a discharged state, and the electrode laminate 1 shown in FIG. 3 is in a charged state. The negative electrode layer 40 in a charged state has a metal deposited layer 42 generated by deposition of a metal ion, a charge negative active material, on the surface on the interlayer 30 side of the negative current collector 41. The metal deposited layer 42 acts as a negative active material layer and releases a metal ion during discharging. The thickness of the negative electrode layer 40 in the electrode laminate 1 varies due to charging and discharging.

The electrode laminate 1 has a rectangular shape having the X direction longer than the Y direction when viewed from the top as shown in FIG. 1. The electrode laminate 1 may also have a square shape or a round shape when viewed from the top.

The positive electrode layer 10, the solid electrolyte layer 20, the interlayer 30 and the negative electrode layer 40 are laminated so that the center C thereof will be superposed on each other. When the area of the positive active material layer 12 when viewed from the top is Sp, the area of the solid electrolyte layer 20 when viewed from the top is Ss, the area of the interlayer 30 when viewed from the top is Sm, and the area of the negative electrode layer 40 when viewed from the top is Sn, a relationship of Sp=Sm=Ss<Sn is satisfied. In the electrode laminate 1, the shapes of the positive active material layer 12, the solid electrolyte layer 20 and the interlayer 30 are the same, and the end portion of the negative electrode layer 40 on the insulating frame 35 is located outside the end portion of the positive active material layer 12 when viewed from the top. The ratio of the area Sn of the negative electrode layer 40 to the area Sp of the positive active material layer 12 Sn/Sp may be within a range from e.g. 1.05 to 1.45.

The material and shape of the positive current collector 11 are not particularly restricted as long as it has a function of collecting current of the positive electrode layer 10. The area of the positive current collector 11 when viewed from the top is preferably equal to or greater than the one of the positive active material layer 12. Examples of the material for the positive current collector 11 can include aluminum, an aluminum alloy, stainless, nickel, iron and titanium and the like, and among these, aluminum, an aluminum alloy and stainless are preferably used. Examples of the shape of the positive current collector 11 include a foil shape, a plate shape and the like.

The positive active material layer 12 contains at least one positive active material. The positive active material is not particularly restricted, and those used in a positive electrode layer of common solid-state secondary batteries can be used. As the positive active material, e.g. a layered active material, a spinel type active material, and an olivine type active material, which contain lithium, can be used. Specific examples of the positive active material include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganese oxide (LiMn₂O₄), a different element-substituted Li-Mn spinel represented by Li₁₊ₓMn_{2-x-y}MO₄ (x+y=2, M=at least one selected from Al, Mg, Co, Fe, Ni and Zn), lithium titanate (Li and Ti-containing oxide), lithium metal phosphate (LiMPO₄, M=at least one selected from Fe, Mn, Co and Ni) and the like.

The positive active material layer 12 may optionally include a solid electrolyte from the viewpoint of improving the conductivity of charge transfer medium. The positive active material layer 12 also may optionally include a conducting aid to improve electrical conductivity. The positive active material layer 12 further may optionally include a binder from the viewpoint of e.g. displaying flexibility. The solid electrolyte, conducting aid and binder are not particularly restricted, and those used in a positive electrode layer of common solid-state secondary batteries can be used.

The solid electrolyte layer 20 is a layer laminated between the positive electrode layer 10 and the negative electrode layer 40. The solid electrolyte layer 20 contains at least one solid electrolyte material. The solid electrolyte layer 20 can conduct a charge transfer medium between the positive electrode layer 10 and the negative electrode layer 40 through a solid electrolyte material included in the solid electrolyte layer 20.

The solid electrolyte material is not particularly limited as long as it has the conductivity of charge transfer medium, and a sulfide solid electrolyte material, an oxide solid electrolyte material, a nitride solid electrolyte material, and a halide solid electrolyte material, for example, can be used.

Examples of the sulfide solid electrolyte material include Li_{z}S—P₂S₅, Li₂S—P₂S₅—LiI and the like. It should be noted that the above description “Li₂S—P₂S₅” means a sulfide solid electrolyte material formed using raw material compositions including Li₂S and P₂S₅, and the same applies to the similar descriptions. The sulfide solid electrolyte material may have an argyrodite crystal structure.

Examples of the oxide solid electrolyte material include a NASICON-type oxide, a garnet-type oxide, a perovskite-type oxide and the like. Examples of the NASICON-type oxide include oxides containing Li, Al, Ti, P and O (e.g. Li_{1.5}Al_{0.5}Ti_{1.5} (PO₄)₃). Examples of the garnet-type oxide includes oxides containing Li, La, Zr and O (e.g. Li₇La₃Zr₂O₁₂). Examples of the perovskite-type oxide include oxides containing Li, La, Ti and O (e.g. LiLaTiO₃).

The solid electrolyte layer 20 may include a binder. The binder is not particularly restricted, and those used in a solid electrolyte layer of common solid-state secondary batteries can be used.

The porosity of the solid electrolyte layer 20 is lower than the porosity of the interlayer 30 described below and is, for example, less than 10%. In addition, the particle diameter of the solid electrolyte material forming the solid electrolyte layer 20 is, for example, 0.5 to 10 μm as the median diameter (D50), and is preferably larger than that of the particles forming the interlayer 30 described below.

The porosity of the solid electrolyte layer 20 can be obtained, for example, by the formula (1) below. It should be noted that the “filling rate” in the formula (1) means the percentage of the density of the solid electrolyte layer after being shaped to the true density. Porosity (%)=(100−filling rate (%)) . . . (1).

In the solid electrolyte layer 20, the water amount after drying in a vacuum state at 110° C. for an hour at less than 100 Pa may be 700 ppm by mass or less or 500 ppm by mass or less. By using the solid electrolyte layer 20 having a small water amount, a reduction in the ion conductance of the solid electrolyte layer is suppressed, also changes in properties of the positive electrode layer 10, the interlayer 30 and the negative electrode layer 40 by water can be suppressed, and cycle characteristics of the solid-state secondary battery 100 are further improved. It should be noted that the water amount after drying is measured using Karl Fischer method.

The interlayer 30 is a layer laminated between the solid electrolyte layer 20 and the negative electrode layer 40. The interlayer 30 has functions of suppressing uneven deposition of a metal ion on the negative electrode layer 40 interface and improving interface adhesion.

It is preferred that the interlayer 30 have electron conductivity, and also have voids through which a metal ion (e.g. lithium ion), a charge transfer medium, can pass. Because the interlayer 30 has the voids, when the solid-state secondary battery 100 is charged, a metal ion, which transfers from the solid electrolyte layer 20 to the negative electrode layer 40, passes through the interlayer 30 and is deposited on the surface on the interlayer 30 side of the negative current collector 41 in the negative electrode layer 40 to generate the metal deposited layer 42 (lithium metal layer). By allowing the metal ion to pass through the interlayer 30, the metal deposited layer 42 can be uniformly generated on the surface of the negative current collector 41. Because of the voids, the interlayer 30 also has pliability which can follow changes in the thickness of the negative electrode layer 40 with charging and discharging. Therefore, even when the solid-state secondary battery 100 is repeatedly charged and discharged, interface adhesion can be maintained, and the durability of the solid-state secondary battery 100 can be improved.

The porosity of the interlayer 30 is preferably higher than the porosity of the solid electrolyte layer 20. Therefore, many voids through which a metal ion can pass are formed inside the interlayer 30, and thus the metal deposited layer 42 can be more uniformly generated on the surface of the negative current collector 41. In addition, the interlayer 30 is more pliable, and thus the followability properties to changes in the thickness of the negative electrode layer 40 are further improved. The porosity of the interlayer 30 can be, for example, 40 to 70%. As the method for calculating the porosity of the interlayer 30, the method for calculating the porosity of the solid electrolyte layer 20 can be applied.

The thickness of the interlayer 30 may be 5 μm or less. When the thickness of the interlayer 30 is 5 μm or less, the deposition site of metal, the charge transfer medium, during charging can be between the interlayer 30 and the negative electrode layer 40. Because of this, the frequency with which the solid electrolyte layer 20 and deposited metal directly come into contact with each other can be largely reduced, local deterioration and electro-current constriction of the solid electrolyte layer 20 are suppressed, and cycle characteristics and storage characteristics are improved. A relatively elastic interlayer 30 can be also placed between the solid electrolyte layer 20 and deposited metal, which are hard, thereby easily following expansion and contraction due to the deposition and dissolution of metal, being able to cause uniform reaction in the in-plane and thickness directions, and obtaining the effects of reducing resistance and improving cycle characteristics. Furthermore, in order to obtain the effects of reducing resistance and improving cycle characteristics, the thickness of the interlayer may be 3 μm or less, or within a range from 1 to 3 μm.

The interlayer 30 preferably includes amorphous carbon and metal nanoparticles. The interlayer 30 may further include a binder as a binding material to retain the structure thereof.

Unlike e.g. graphite, amorphous carbon is difficult to react with metal such as lithium to form an alloy, and thus can suppress the formation of dendrite, and can improve the cycle characteristics of the solid-state secondary battery. Amorphous carbon may be an easily graphitizable carbon (soft carbon) or poorly graphitizable carbon (hard carbon). In addition, amorphous carbon may be one which does not show a clear crystal state among carbon allotropes, or aggregates of fine graphite crystals. Specific examples of amorphous carbon include carbon blacks such as acetylene black, furnace black and ketjen black, coke, active carbon, CNT (carbon nanotube), fullerene and graphene.

Examples of metal nanoparticles include metal nanoparticles of tin (Sn), silicon (Si), zinc (Zn), magnesium (Mg), gold (Au), platinum (Pt), palladium (Pd), silver (Ag), aluminum (Al), bismuth (Bi), antimony (Sb) and the like. The amount of metal nanoparticles contained is preferably above 0 mass % and 30 mass % or less in the interlayer 30. When the interlayer 30 includes metal nanoparticles, the electron conductivity of the interlayer 30 can be increased, and the metal deposited layer 42 can be more uniformly generated. In addition, because metal nanoparticles has a higher Young's modulus than that of amorphous carbon, the structure of the interlayer 30 can be retained even when pressed at a high pressure in the production of the solid-state secondary battery 100.

The particle diameters of amorphous carbon and particles such as metal nanoparticles are preferably smaller than the particle diameter of the solid electrolyte material. Therefore, the interlayer 30 can enter gaps between solid electrolyte materials forming the solid electrolyte layer 20 interface, and thus the contact area between the solid electrolyte layer 20 and the interlayer 30 can be increased, and also adhesive properties can be improved. The particle diameter of amorphous carbon may be, for example, within a range from 0.02 to 0.10 μm as the median diameter (D50). The particle diameter of metal nanoparticles may be, for example, within a range from 0.02 to 0.20 μm as the median diameter (D50).

The binder is preferably those which can improve adhesive properties between particles forming the interlayer 30 and between the interlayer 30 and the solid electrolyte layer 20. The binder is not particularly restricted, and those commonly used in solid-state secondary batteries can be used. Examples of the binder include an acrylic acid-based polymer, a cellulose-based polymer, a styrene-based polymer, a vinyl acetate-based polymer, a urethane-based polymer, a fluoroethylene-based polymer and the like, and a PVDF-based polymer.

The insulating frame 35 has a volume resistivity at 20° C. of 1×10¹² Ω·cm or more. The volume resistivity may be within a range from 1×10¹² to 1×10¹⁷ Ω·cm or a range from 1×10¹⁴ to 1×10¹⁷ Ω·cm. The insulating frame 35 has a porosity of 40% or less. The porosity may be 20% or less or within a range from 1 to 20%. When the porosity is too high, there is a risk that it is difficult to retain the structure of the insulating frame 35 at the time of high pressure pressing in the battery production process, and there is also a higher risk that deposited metal will physically enter the inside of the insulating frame 35 during charging and discharging and cause a short circuit.

The insulating frame 35 may be an organic substance or an inorganic substance. Examples of insulating materials included in the insulating frame 35 include rubber, glass, resin (polyimide, polybenzimidazole, polyamideimide, polyetherimide, polyacetal, polyphenylenesulfide, polyetheretherketone, tetrafluoroethylene, polyamide 6 (nylon 6), ultra-high molecular weight polyethylene, polyethylene, polypropylene, vinyl chloride resin, polystyrene, polyethylene terephthalate, ABS resin, etc.), ceramics (alumina, zirconia, silicon nitride, aluminum nitride, mullite, steatite, magnesia, sialon, macerite, etc.) The insulating materials may be used individually, or a composite material by the combination of two or more materials may be used. The insulating frame 35 may also include a small amount of binding material and additives. The dielectric breakdown voltage per unit thickness of the insulating frame 35 is preferably 10 kV/mm or more and further preferably 100 kV/mm or more.

The negative current collector 41 is a laminate having a current collector base material 41a and a metal layer 41b laminated on the surface of the current collector base material 41a. The material and shape of the current collector base material 41a are not particularly restricted as long as it has a function of collecting current of the negative electrode layer 40. Examples of the material of the current collector base material 41a include nickel, copper and stainless and the like. Examples of the shape of the current collector base material 41a include a foil shape, a plate shape and the like.

The material and shape of the metal layer 41b are not particularly restricted as long as it has a function of densely depositing the charge transfer medium such as lithium ion. When the charge transfer medium is lithium ion, lithium metal or metal which forms an alloy with lithium can be used as the material for the metal layer 41b. Examples of the metal which forms an alloy with lithium include Mg, Si, Au, Ag, In, Ge, Sn, Pb, Al and Zn and the like. The metal which forms the metal layer 41b may be in a powder shape or a thin film shape. Using the negative current collector 41 having this metal layer 41b, a uniform metal deposited layer 42 can be formed on the surface of the negative current collector 41. It should be noted that the metal layer 41b may be omitted and lithium ion may be directly deposited on the current collector base material 41a.

As shown in FIG. 4, the electrode laminate 1 is housed in an outer case 50. A pair of restraining members 60 to provide a restraining force for the electrode laminate 1 are placed on the outer surface of the outer case 50. The solid-state secondary battery 100 has a positive electrode tab (not shown) having one end portion connected to the positive current collector 11 and another end portion projected to the outside, and a negative electrode tab (not shown) having one end portion connected to the negative current collector 41 and another end portion projected to the outside.

The outer case 50 can expand and contract with changes in the thickness of the negative electrode due to charging and discharging. As the material of the outer case 50, a laminate film can be used. As the laminate film, laminated films having a three layer structure can be used in which from the inner side, an inner resin layer, a metal layer and an outer resin layer are laminated in this order. The outer resin layer may be, for example, a polyamide (nylon) layer or a polyethylene terephthalate (PET) layer, and the metal layer may be, for example, an aluminum layer, and the inner resin layer may be, for example, a polyethylene layer or a polypropylene layer. An adhesive agent layer may be also included between the layers, and the layers may be also integrated by e.g. heating and pressure.

In order to secure clearance inside the outer case 50, the ratio of the thickness of the positive electrode layer 10 to the thickness of the negative electrode layer 40 (the thickness of the negative current collector 41) in a discharged state (the thickness of the positive electrode layer 10/the thickness of the negative electrode layer 40) may be 1.9 or more.

The restraining member 60 provides a restraining force in the laminate direction of the electrode laminate 1. When the area of the restraining member 60 when viewed from the top is Sr and the area of the negative electrode layer 40 when viewed from the top is Sn, a relationship of Sn≤Sr is preferably satisfied. When the area Sr of the restraining member 60 satisfies this relationship, a restraining force uniformly acts on the surface of the negative electrode layer 40. Because of this, a metal ion can be evenly deposited on the surface of the negative electrode layer 40 during charging, and thus metal is difficult to accumulate on the end portions of the solid electrolyte layer 20 and the interlayer 30. The material of the restraining member 60 is not particularly restricted, and those commonly used for solid-state batteries can be used. The restraining force by the restraining member 60 to the electrode laminate 1 may be, for example, within a range from 0.1 to 10 MPa. The method for producing the solid-state secondary battery 100 of the present embodiment will now be described. The electrode laminate 1 can be produced, for example, by a method including forming a positive active material layer, placing an insulating frame, forming a solid electrolyte layer, forming an interlayer, and forming a negative electrode layer.

The step of forming a positive active material layer is a step of forming the positive active material layer 12 on the surface of the positive current collector 11. As the method for forming the positive active material layer 12, a method can be used in which a positive active material layer slurry is applied and dried. As the positive active material layer slurry, a positive active material dispersed liquid, containing a solvent, a positive active material and optionally a conducting aid and a binder can be used.

The step of placing an insulating frame is a step of placing the insulating frame 35 to the circumference of the positive active material layer 12. As the method for placing the insulating frame 35, for example, a method can be used in which an insulating frame slurry is applied to the circumference of the positive active material layer 12 and dried to form an insulating frame. As the insulating frame slurry, for example, an insulating material dispersed liquid, containing a solvent, an insulating material and optionally a binder can be used.

The step of forming a solid electrolyte layer is a step of forming the solid electrolyte layer 20 on the surface of the positive active material layer 12 in the positive electrode layer 10. As the method for forming the solid electrolyte layer 20, a method in which a solid electrolyte layer slurry is directly applied to the surface of the positive active material layer 12 and dried, or a method in which the solid electrolyte layer 20, formed by applying a solid electrolyte layer slurry to the surface of a separately prepared supporting sheet and drying the slurry, is transferred to the surface of the positive active material layer 12 by a predetermined pressure can be used. As the solid electrolyte layer slurry, for example, a solid electrolyte dispersed liquid, containing a solvent, a solid electrolyte and optionally a binder can be used. In addition, as the method for forming the solid electrolyte layer 20, a method can be used in which a solid electrolyte layer is integrated with a base material and self-supported and then placed on the positive electrode layer. A nonwoven fabric and a woven fabric, for example, can be used as the base material. As the material of the base material, a polyester resin such as PET can be used.

The step of forming an interlayer is a step of forming the interlayer 30 on the surface opposite to the positive active material layer 12 side of the solid electrolyte layer 20. As the method for forming the interlayer 30, a method in which an interlayer slurry is directly applied to the surface of the solid electrolyte layer 20 and dried, or a method in which the interlayer 30, formed by applying an interlayer slurry to the surface of a separately prepared supporting sheet and drying the slurry, is transferred to the surface of the solid electrolyte layer 20 by a predetermined pressure can be used. As the interlayer slurry, for example, an interlayer forming material dispersed liquid, containing a solvent, metal nanoparticles, amorphous carbon and optionally a binder can be used.

The step of forming a negative electrode layer is a step of forming the negative electrode layer 40 on the surface opposite to the solid electrolyte layer 20 side of the interlayer 30. As the method for forming the negative electrode layer 40, a method can be used in which the negative current collector 41 prepared beforehand is placed on the surface of the interlayer 30.

The steps of forming an interlayer and forming a negative electrode layer may be performed at the same time. For example, the interlayer 30 in an interlayer-negative electrode layer laminate, in which the interlayer 30 and the negative electrode layer 40 are integrated and self-supported beforehand, may be placed on the surface of the solid electrolyte layer 20. The interlayer-negative electrode layer laminate can be obtained, for example, by applying an interlayer slurry to the surface of the negative current collector 41 and drying the slurry to form the interlayer 30.

As described above, the electrode laminate 1 is obtained in which the positive electrode layer 10, the solid electrolyte layer 20, the interlayer 30 and the negative electrode layer 40 are laminated in this order. The obtained electrode laminate 1 may be optionally integrated by pressing.

The solid-state secondary battery 100 can be produced as follows. One end portion of the positive electrode tab is connected to the positive current collector 11 of the obtained electrode laminate 1, and one end portion of the negative electrode tab is connected to the negative current collector 41. Next, the electrode laminate 1 is housed in the outer case 50 so that another end portion of the positive electrode tab and the negative electrode tab is projected therefrom, and the outer case 50 is sealed. The restraining members 60 are placed on the outer surfaces of the outer case 50 to restrain the electrode laminate 1 with a predetermined restraining force.

According to the solid-state secondary battery 100 of the present embodiment having the structure as described above, the circumferences of the positive active material layer 12, the solid electrolyte layer 20 and the interlayer 30 are surrounded by the insulating frame 35 having the above-described volume resistivity and porosity, and thus a metal ion released from the positive electrode layer 10 and the negative electrode layer 40 is difficult to deposit on the end portions of the solid electrolyte layer 20 and the interlayer 30 during charging and discharging. Because of this, the positive electrode layer 10 and the negative electrode layer 40 are less likely to cause a short circuit. Therefore, the solid-state secondary battery 100 of the present embodiment has good cycle characteristics.

According to the solid-state secondary battery 100 of the present embodiment, when the porosity of the insulating frame is as low as 20% or less, because the void diameter in the insulating frame 35 is small and the structure of the insulating frame 35 is easily retained, a metal ion released from the positive electrode layer 10 and the negative electrode layer 40 is more difficult to deposit on the end portions of the solid electrolyte layer 20 and the interlayer 30 during charging and discharging. Because of this, the positive electrode layer 10 and the negative electrode layer 40 are further less likely to cause a short circuit. In the solid-state secondary battery 100 of the present embodiment, when the porosity of the interlayer 30 is greater than the porosity of the solid electrolyte layer 20, uneven deposition of metal on the negative electrode layer 40 interface can be suppressed, and cycle characteristics can be further improved. In the solid-state secondary battery 100 of the present embodiment, when the interlayer 30 includes metal nanoparticles and amorphous carbon, the electron conductivity of the interlayer 30 can be secured, and also particles forming the interlayer 30 and the charge transfer medium can be prevented from reacting to form an alloy. In the solid-state secondary battery 100 of the present embodiment, furthermore, when the negative active material is lithium metal, a high capacity can be obtained.

The embodiments of the present invention have been illustrated above. It should be noted, however, that the present invention is not limited to the above embodiments. In the solid-state secondary battery 100 of the present embodiment, for example, the metal deposited layer 42 is used as the negative active material layer; however, the negative active material layer is not limited thereto. The negative active material layer may be also a layer including a negative active material which can absorb and release the charge transfer medium such as lithium ion. In this case, the negative active material layer may be also placed on the surface of the current collector base material 41a. As the negative active material, those used in a negative electrode of common solid-state secondary batteries can be used. When the charge transfer medium is lithium ion, examples of the negative active material include lithium transition metal oxides such as lithium titanate, transition metal oxides such as TiO₂, Nb₂O₃ and WO₃, Si, SiO, metal sulfide, metal nitride, and carbon materials such as artificial graphite, natural graphite, graphite, soft carbon and hard carbon. The negative active material layer may optionally include a solid electrolyte from the viewpoint of improving the conductivity of charge transfer medium. The negative active material layer also may optionally include a conducting aid to improve electrical conductivity. The negative active material layer further may optionally include a binder from the viewpoint of e.g. displaying flexibility. As the solid electrolyte, conducting aid and binder, those commonly used in solid-state batteries can be used.

In addition, the solid-state secondary battery 100 of the present embodiment has the interlayer 30, and the insulating frame 35 is extended to the circumference of the interlayer 30. The present invention, however, is not limited thereto. In the solid-state secondary battery 100 of the present embodiment, a metal ion is difficult to deposit on the end portion of the solid electrolyte layer 20, and thus the positive electrode layer 10 and the negative electrode layer 40 are less likely to cause a short circuit even when the insulating frame 35 is not extended to the circumference of the interlayer 30.

### EXAMPLES

The present invention will now be described in detail by way of examples. It should be noted, however, that the present invention is not limited to these examples.

### Example 1

### [Production of Positive Active Material Layer]

Rectangular aluminum foil with an X direction length of 30.0 mm×a Y direction length of 30.0 mm×a thickness of 15.0 μm was prepared as a positive current collector. Lithium-nickel-cobalt-manganese composite oxide (NCM622) as a positive active material, an argyrodite type sulfide solid electrolyte as a solid electrolyte, carbon black as a conducting aid, and an SBR (styrene butadiene rubber)-based binder as a binding material were mixed in the proportion of 80 parts by mass, 17 parts by mass, 2 parts by mass and 1 part by mass, respectively. The obtained mixture was dispersed in 43 parts by mass of butyl butyrate to prepare a positive active material layer slurry. The obtained positive active material layer slurry was applied using a bar coater to the center of the positive current collector so that the X direction length, Y direction length and weight after drying were 20.0 mm, 20.0 mm and 27 mg/cm², respectively, and dried to produce a positive active material layer with a thickness of 80.0 μm.

### [Production of Insulating Frame]

Alumina (Al₂O₃) particles (median diameter: 0.4 μm) as an insulating material, and an SBR-based binder as a binding material were mixed in the proportion of 90 parts by mass and 10 parts by mass, respectively. The obtained mixture was dispersed in 120 parts by mass of butyl butyrate to prepare an insulating frame slurry. The obtained insulating frame slurry was applied using a spray coater to the part not having the formed positive active material layer in the positive current collector so that the weight after drying was 20 mg/cm², and dried to produce an insulating frame.

### [Production of Solid Electrolyte Layer]

An argyrodite type sulfide solid electrolyte (median diameter: 3.0 μm) dispersed liquid was applied to a supporting sheet and dried to form an argyrodite type sulfide solid electrolyte layer with an X direction length of 27.00 mm×a Y direction length of 27.0 mm. The argyrodite type sulfide layer formed on the supporting sheet was transferred to the center of the positive active material layer to produce a solid electrolyte layer.

### [Production of Interlayer]

A total of 95 parts by mass of Sn particles (median diameter: 0.07 μm) as metal nanoparticles and acetylene black (median diameter: 0.05 μm) as amorphous carbon, and 5 parts by mass of a PVDF-based binder as a binding material were mixed in this proportion. The obtained mixture was dispersed in 1000 parts by mass of NMP (N-methyl-2-pyrrolidone) to prepare an interlayer slurry. The obtained interlayer slurry was applied to base foil using a gravure coater so that the weight was 0.4 mg/cm², and dried. It was placed on the center of the solid electrolyte layer and transferred with a predetermined pressure to produce an interlayer with an X direction length of 22.0 mm×a Y direction length of 22.0 mm×a thickness after pressing of 3.0 μm. As described above, a positive electrode layer—solid electrolyte layer—interlayer laminate with the insulating frame was obtained in which the positive electrode layer, the solid electrolyte layer and the interlayer were laminated in this order and the circumferences thereof were surrounded by the insulating frame.

### [Production of Negative Current Collector]

Copper foil with a thickness of 10 μm and lithium foil with a thickness of 40 μm were laminated to prepare laminated metal foils (total thickness: 50 μm). The laminated metal foils were cut into a size of a X direction length of 21.0 mm×a Y direction length of 21.0 mm to produce a negative current collector.

### [Production of Electrode Laminate]

The positive electrode layer—solid electrolyte layer—interlayer laminate with the insulating frame obtained above was retained by isostatic press forming under conditions of heating temperature of 120° C. and a pressing pressure of 980 MPa for 5 minutes to densify each layer. Next, the negative current collector obtained above was placed so that the lithium foil was brought into contact with the surface of the interlayer in the positive electrode layer—solid electrolyte layer—interlayer laminate with the insulating frame, and then pressed to produce an electrode laminate in which the positive electrode layer, the solid electrolyte layer, the interlayer and the negative current collector were laminated in this order.

### [Production of Solid-State Secondary Battery]

A tab was attached to each of the positive current collector and the negative current collector of the electrode laminate obtained above, and the electrode laminate was then held in a laminate pouch pack. The laminate pack was then sealed under an argon atmosphere.

A restraining member with an X direction length of 21.00 mm and a Y direction length of 21.0 mm was prepared. The restraining members were placed to face the negative current collector of the electrode laminate from the surface of the laminate pack, and provided a restraining force of 3 MPa for the electrode laminate to produce a solid-state secondary battery.

### Examples 2 to 4 and Comparative Examples 1 to 2

A solid-state secondary battery was produced in the same manner as in Example 1 except that the heating temperature and pressing pressure at the time of densification of an electrode laminate were changed to the temperature and pressure in Table 1 below.

### <Physical Properties of Insulating Frame>

The insulating frame was taken out from the electrode laminate produced in Examples 1 to 3 and Comparative Examples 1 to 2. The volume resistivity (20° C.) and true density of the obtained insulating frame were measured. The apparent density and true density of the insulating frame were also measured, and the porosity was calculated from the obtained true density and apparent density (=apparent density/true density×100). The apparent density was calculated by the weight and size of the insulating frame.

### <Battery Characteristics>

The solid-state secondary batteries produced in Examples 1 to 3 and Comparative Examples 1 to 3 were subjected to a cycle test by repeating charging and discharging at an upper limit charging voltage of 4.3 V, a lower limit discharging voltage of 2.65V and a C rate of ⅓ C. The percentage of the first discharge capacity to the first charge capacity (first discharge capacity/first charge capacity×100) was considered the initial charge-discharge efficiency. When the percentage of the first discharge capacity to the second charge capacity (second charge capacity/first discharge capacity×100) was above 105%, the short circuit behavior at the time of second charging was described as “yes” and when the percentage of the first discharge capacity to the second charge capacity was 105% or less, the short circuit behavior at the time of second charging was described as “no”. The results are shown in Table 1.

TABLE 1

| | | | | | Battery | |
|---|---|---|---|---|---|---|
| | Conditions for | | | | characteristics | |
| | densifying electrode | | Physical properties | | Initial | Short- |
| | laminate | | of insulating frame | | charge- | circuit |
| | Heating | Pressing | Volume | | discharge | behavior |
| | temperature | pressure | resistivity | Porosity | efficiency | at second |
| | (° C.) | (MPa) | (Ω · cm) | (%) | (%) | charging |
| Example 1 | 120 | 980 | 1 × 10¹² | 18 | 88.6 | no |
| Example 2 | 25 | 980 | 1 × 10¹⁴ | 35 | 88.8 | no |
| Example 3 | 130 | 980 | 1 × 10¹⁶ | 15 | 88.5 | no |
| Example 4 | 140 | 980 | 1 × 10¹⁷ | 5 | 88.5 | no |
| Comparative | 25 | 900 | 1 × 10¹² | 50 | 79.3 | yes |
| Example 1 | | | | | | |
| Comparative | 25 | 950 | 1 × 10¹⁰ | 48 | 68.3 | yes |
| Example 2 | | | | | | |

The results shown in Table 1 found that the solid-state secondary batteries with the insulating frame in accordance with the present invention obtained in Examples 1 to 3 had a high initial charge-discharge efficiency and was less likely to cause a short circuit. Contrarily, it was found that in the solid-state secondary battery obtained in Comparative Example 1 in which the porosity of the insulating frame was greater than the range of the present invention, and the solid-state secondary batteries in Comparative Examples 1 to 2 in which the porosity of the insulating frame was greater than the range of the present invention and the volume resistivity was smaller than the range of the present invention, the initial charge-discharge efficiency was low and a short circuit easily occurred. This is because lithium is deposited on voids in the insulating frame during charging.

### EXPLANATION OF REFERENCE NUMERALS

1 Electrode laminate
10 Positive electrode layer
11 Positive current collector
12 Positive active material layer
20 Solid electrolyte layer
30 Interlayer
35 Insulating frame
40 Negative electrode layer
41 Negative current collector
41a Current collector base material
41b Metal layer
42 Metal deposited layer
50 Outer case
60 Restraining member
100 Solid-state secondary battery

What is claimed is:

1. A solid-state secondary battery, comprising an electrode laminate and an outer case to house the electrode laminate,
the electrode laminate having a positive electrode layer, a negative electrode layer and a solid electrolyte layer placed between the positive electrode layer and the negative electrode layer,
the positive electrode layer having a positive current collector and a positive active material layer,
circumferences of the positive active material layer and the solid electrolyte layer being surrounded by an insulating frame having a volume resistivity at 20° C. of 1×10¹² Ω·cm or more and a porosity of 40% or less.

2. The solid-state secondary battery according to claim 1, wherein the porosity of the insulating frame is 20% or less.

3. The solid-state secondary battery according to claim 1, having an interlayer placed between the negative electrode layer and the solid electrolyte layer,
wherein a porosity of the interlayer is greater than a porosity of the solid electrolyte layer.

4. The solid-state secondary battery according to claim 3, wherein the insulating frame is extended to a circumference of the interlayer.

5. The solid-state secondary battery according to claim 3, wherein a thickness of the interlayer in a laminate direction of the electrode laminate is 5 μm or less.

6. The solid-state secondary battery according to claim 3, wherein the interlayer comprises metal nanoparticles and amorphous carbon.

7. The solid-state secondary battery according to claim 1, wherein a negative active material is lithium metal.
